(19) United States
(12) Patent Application Publication
(10) Pub. No.: US 2017/0051911 A1
(43) Pub. Date: Feb. 23, 2017

(54) WATERPROOF LED LAMP AND LED LAMP SET

(71) Applicant: Qingbo XIE, Shenzhen, Guangdong (CN)

(72) Inventor: Qingbo XIE, Shenzhen, Guangdong (CN)

(21) Appl. No.: 15/308,023

(22) PCT Filed: Apr. 29, 2014
(86) PCT No.: PCT/CN2014/076440

§ 371 Date: Oct. 31, 2016

(51) Int. Cl. F21V 31/00; F21V 21/005; F21V 15/015; F21V 23/00; H05B 33/08; F21V 3/02; F21V 29/89; F21V 29/83; F21V 21/14; H05B 37/02

(52) U.S. Cl. CPC F21V 31/005; F21V 21/14; F21V 21/005; F21V 15/015; H05B 37/0218; H05B 33/0854; F21V 3/02; F21V 29/89; F21V 29/83; F21V 23/005; F21Y 2115/10

(57) ABSTRACT

A waterproof LED lamp includes a lamp body. The lamp body includes a heat dissipation housing having an opening slot, and a transparent outer cover enclosing a first sealed cavity with the heat dissipation housing. At least one set of LED modules are disposed in the first sealed cavity. Each LED module includes a cavity and a transparent inner cover enclosing a second sealed cavity with the cavity. Each transparent inner cover faces the transparent outer cover. The second sealed cavity is provided with a plurality of LED light sources and a PCB board having a control circuit. Each ED light source faces the transparent inner cover. Also provided is an LED lamp set including a plurality of waterproof LED lamps. Each LED light source of the waterproof LED lamp is disposed in the second sealed cavity, and the second sealed cavity is located in the first sealed cavity.

### TECHNICAL FIELD

The present application relates to the technical field of LED lamps, and more particularly, relates to a waterproof LED lamp and an LED lamp set.

### BACKGROUND

LED lamps, especially the LED lamps used outdoors, such as car lights, navigation lights, road lights and so on, should all be provided with a certain waterproof performance, thereby ensuring working lives of the LED lamps. An LED lamp in the prior art is formed by pressing two aluminum pieces together, and the two aluminum pieces are closed to form a cavity, the cavity is configured to mount LED light sources; in order to provide a certain waterproof performance, a waterproof silica gel is clamped at the junction of the two aluminum pieces, and the two aluminum pieces press the waterproof silica gel. However, due to inaccurate pressing, the two aluminum pieces often result in that the waterproof silica gel is not uniformly pressed, such that the silica gel is deformed, and the waterproof performance of the LED lamp is further affected.

### Technical Problem

A purpose of the present application is providing a waterproof LED lamp, which aims at solving a problem that an LED lamp in the prior art has a weak waterproof performance.

### Technical Solution

In order to solve the aforesaid technical problem, a technical solution of the present application is: providing a waterproof LED lamp comprising a lamp body, wherein the lamp body comprises a dissipation housing having an open slot and a transparent outer cover, the transparent outer cover and the dissipation housing are assembled together to form a first sealed cavity; the first sealed cavity is provided therein with at least one group of LED modules, each of the LED modules comprises a chamber body and a transparent inner cover, the transparent inner cover and the chamber body are assembled together to form a second sealed cavity, and each transparent inner cover faces the transparent outer cover; the second sealed cavity is provided therein with a plurality of LED light sources and a PCB having a control circuit, and each of the LED light sources faces the transparent inner cover.

Further, the dissipation housing is provided thereon with a plurality of vent holes configured for communicating each of the second sealed cavities with exterior space, and each of the vent holes is provided therein with a waterproof and breathable film configured to prevent external water vapor from entering each of the second sealed cavities.

Furthermore, the waterproof LED lamp further comprises photosensitive elements which are arranged respectively in each of the second sealed cavities so as to obtain light intensity information of incident light that enters each of the second sealed cavities from the exterior space and face the transparent inner covers, and information processing devices configured to process information obtained by the photosensitive elements so as to control each of the LED light sources to emit light.

Furthermore, each of the second sealed cavities is provided therein with an LED backlight source configured to emit color light.

Furthermore, the waterproof LED lamp further comprises a mounting support configured to fix the lamp body to a mounting member and capable of adjusting a mounting angle of the lamp body, the mounting support comprises a mounting base that can be fixed on the mounting member and two connecting components configured to fix the mounting base to the lamp body; the mounting base has two connecting ends arranged oppositely and connected with the two connecting components correspondingly, each of the connecting ends is provided with arc-shaped sliding grooves and a locating hole, the locating hole is located at a center of a circle of one of the arc-shaped sliding grooves; each of the connecting components comprises two first connecting rods configured to fix one of the connecting ends to the lamp body, one of the connecting rods passes through and is fixed in the locating hole and is in threaded connection with the lamp body, the other one of the first connecting rods is slidably arranged in the sliding slots and is in threaded connection with the lamp body.

Furthermore, each of the chamber bodies is provided therein with a laser transmitter configured to emit an intense light beam.

Furthermore, each of the chamber bodies is provided with two embedded connecting terminals, an inner side of each of the connecting terminals is electrically connected with a control circuit of the PCB, and outer sides of the two connecting terminals are respectively electrically connected with an input wire and an output wire of the chamber body.

Specifically, the first sealed cavity is provided therein with one group of LED module, an inner side of each of the two connection terminals is electrically connected with the PCB, and outer sides of the two connection terminals are respectively electrically connected with an input wire and an output wire of the lamp body.

Specifically, the first sealed cavity is provided therein with a plurality of groups of LED modules, the LED modules are arranged linearly and sequentially; one connecting terminal of each of the LED modules located in the middle is connected in an insertion manner with one connecting terminal of a previous LED module, and the other connecting terminal of the LED module located in the middle is connected in an insertion manner with one connecting terminal of a following LED module; one connecting terminal of an LED module located at one end is connected in an insertion manner with one connecting terminal of an adjacent LED module, and the other connecting terminal of the LED module located at the end is electrically connected with the input wire of the lamp body; one connecting terminal of an LED module located at the other end is connected in an insertion manner with an connecting terminal of an adjacent LED module, and the other connecting terminal of the LED module located at the other end is electrically connected with the output wire of the lamp body.

The present application further provides an LED lamp set comprising a plurality of the aforesaid waterproof LED lamps, wherein the waterproof LED lamps are arranged linearly, and adjacent ones of the waterproof LED lamps are electrically conductive and detachably connected.

### Advantageous Effects of the Present Application

The present application has the following technical effects: in the LED lamp of the present application, the lamp body comprises the dissipation housing and the transparent outer cover which are assembled together to form the first sealed cavity, the first sealed cavity is provided therein with at least one group of LED units, each LED unit comprises a transparent inner cover and a chamber body, and the LED light sources are all arranged in the second sealed cavity enclosed by the transparent inner cover and the chamber body; moreover, each LED light source faces the transparent inner cover and the transparent outer cover. Therefore, when the LED lamp works, light emitted by each LED light source can traverse the transparent inner cover and the transparent outer cover sequentially and does not affect a lighting effect of the LED lamp; meanwhile, in the LED lamp, each LED light source is arranged in a corresponding second sealed cavity, and the second sealed cavity is located in the first sealed cavity, therefore, when the LED lamp lies in a rainwater environment, external water vapor is not prone to permeate into the first sealed cavity through the transparent outer cover or the dissipation housing; furthermore, each chamber body and the corresponding transparent inner cover can essentially prevent external water vapor from permeating into the second sealed cavity, and thus the LED lamp has a very strong waterproof performance. The LED lamp set of the present application comprises a plurality of the aforesaid LED lamps, the LED lamps are arranged collinearly, and adjacent ones of the LED lamps are detachably assembled and electrically conductive; by this structure, the plurality of LED lamps can be assembled to be a whole; the LED lamp set has an excellent lighting effect, meanwhile, since adjacent ones of the LED lamps are detachably assembled, it is quite convenient to replace the LED lamps in the LED lamp set.

### BRIEF DESCRIPTION OF THE DRAWINGS

FIG. 1 illustrates a structural schematic view of a waterproof LED lamp according to one embodiment of the present application;

FIG. 2 illustrates a front cross-section view of the waterproof LED lamp in FIG. 1;

FIG. 3 illustrates a lateral cross-section view of the LED lamp in FIG. 1;

FIG. 4 illustrates a structural schematic view of a mounting support including a mounting base of the waterproof LED lamp in FIG. 1;

FIG. 5 illustrates a lateral cross-section view of a lamp body of the waterproof LED lamp in FIG. 1, wherein the mounting support comprises a hook component;

FIG. 6 illustrates a lateral view of a hook component included by the mounting support of the waterproof LED lamp in FIG. 1.

### DETAILED DESCRIPTION OF THE PREFERRED EMBODIMENT

In order to make the purposes, technical solutions, and advantages of the present application be clearer and more understandable, the present application will be further described in detail hereinafter with reference to the accompanying drawings and embodiments. It should be understood that the embodiments described herein are only intended to illustrate but not to limit the present application.

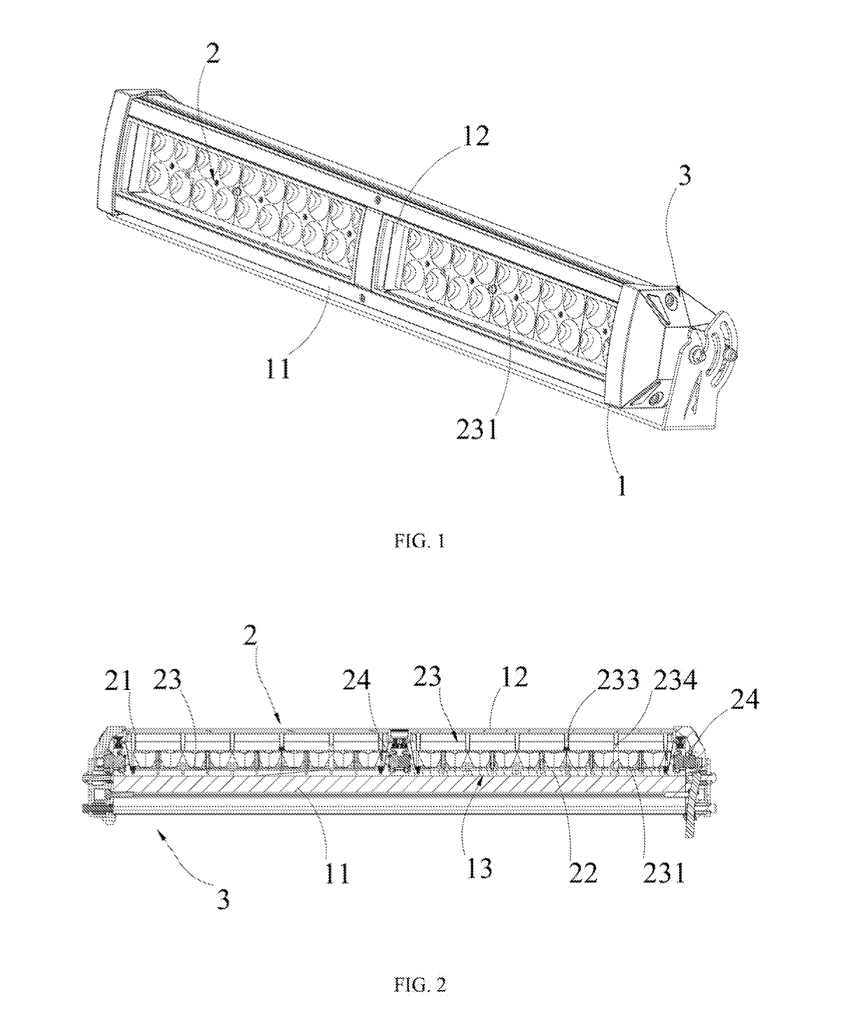

Referring to FIG. 1 and FIG. 2, the present application provides a waterproof LED lamp comprising a lamp body 1, the lamp body 1 comprises a dissipation housing 11 and a transparent outer cover 12, the dissipation outer housing 11 can be made of aluminum material, the transparent outer cover 12 can be made of PC (polycarbonate) material, the dissipation housing 11 and the transparent outer cover 12 are assembled together to form a first sealed cavity 13; the first sealed cavity 13 is provided therein with at least one group of LED modules 2, each of the LED modules comprises a transparent inner cover 21 and a chamber body 22, each of transparent inner covers 21 faces the transparent outer cover 12 and is also made of PC material, and each of chamber body 22 is made of aluminum material and is integrally molded; each of the transparent inner covers 21 and a corresponding chamber body 22 are assembled together to form a second sealed cavity 23, each of second sealed cavities 23 is provided therein with a plurality of LED light sources 231 and a PCB (Printed Circuit Board) 232 having a control circuit; after the LED lamp is normally electrified, the control circuit controls each of the LED light sources 231 to emit light normally; each of the LED light sources 231 faces a corresponding transparent inner cover 21. In this embodiment, each of the transparent inner covers 21 in the first sealed cavity 13 faces the transparent outer cover 12, meanwhile, each of the LED light sources 231 in each of the second sealed cavities 23 faces a corresponding transparent inner cover 21; by this configuration, when the LED lamp works, light emitted from each of the LED light sources 231 can pass through the corresponding transparent inner cover 21 and the transparent outer cover 12 sequentially, and the two layers of transparent covers won't affect a lighting effect of the LED lamp. Moreover, when the LED lamp lies in a rainwater environment, since each of the LED light sources 231 is arranged in the second sealed cavities 23, and each of the second sealed cavities 23 is located in the first sealed cavity 13, only when external water vapor permeates into the first sealed cavity 13 can it permeate from the first sealed cavity 13 into each of the second sealed cavities 23 and thereby affect working lives of the LED light sources 231; therefore, the LED lamp has a very strong waterproof performance, and can essentially prevent external water vapor from entering the second sealed cavities 23; meanwhile, since the chamber bodies 22 are located in the first sealed cavity 13, the transparent outer cover 12 and the dissipation housing 11 can provide protection for the chamber bodies 22. Generally, the transparent outer cover 12 is detachably connected with the dissipation housing 11, the transparent outer cover 12 can have different colors, and a user can change the transparent outer covers 12 of different colors according to requirements, thereby enabling the LED lamp to emit light of different colors. With respect to the structure of the transparent outer cover 12, portions of the transparent outer cover 12 that face each of the transparent inner covers 11 can be designed to be arc-shaped, such that a wind resistance of the lamp body 1 can be effectively reduced, and it is also beneficial to ensure a whole appearance of the lamp body 1; with respect to structures of the transparent inner covers 21, each of the transparent inner covers 21 can also be designed to be arc-shaped; generally, in an actual application, the transparent outer cover 12 are optionally assembled, that is, a user can optionally assemble the transparent outer cover 12 according to his/her own actual requirements; when the LED lamp is not provided with the transparent outer cover 12, each of the transparent inner covers 21 is in contact with the outside; on this condition, each of the transparent inner covers 21 can be designed to be arc-shaped, and the function of reducing the wind resistance can also be effectively performed.

Further, the dissipation housing 11 is provided with vent holes (not shown in the figures), the vent holes can be used to communicate each of the second sealed cavities 23 with exterior space; moreover, each of the vent holes is provided therein with a waterproof and breathable film (not shown in the figures), and the waterproof and breathable film can effectively prevent outer water vapor from entering each of the second sealed cavities 23. When the LED lamp works, each of the LED light sources 231 can dissipate a certain amount of heat when it irradiates, thereby resulting in an increase of a temperature of air in each of the second sealed cavities 23; gas possesses features of thermal expansion and cold contraction, therefore, when the LED light works, gas in each of the second sealed cavities 23 should be discharged from each of the second sealed cavities 23, such that a volume of air in each of the second sealed cavities 23 is reduced, and thus an air pressure in each of the second sealed cavities 23 and an air pressure of the outside environment are kept in balance. In this embodiment, when an intensity of pressure in each of the second sealed cavities 23 increases, the gas can be discharged into the exterior space through the vent holes; similarly, when the LED lamp stops working, the temperature of the gas in each of the second sealed cavities 23 is reduced, the air pressure is reduced, and gas in the exterior space enters each of the second sealed cavities 23 through the vent holes, thereby keeping the air pressure in each of the second sealed cavities 23 and the atmosphere pressure in the exterior space being in balance; the waterproof and breathable film in each of the vent holes can prevent water vapor from entering the second sealed cavities 23 when gas flows between each of the second sealed cavities 23 and the exterior space, and thereby provides a waterproof function. Moreover, the breathable structure adopting the aforesaid structures is not protruded from the dissipation housing 11 and thus can be avoided from being damaged by colliding.

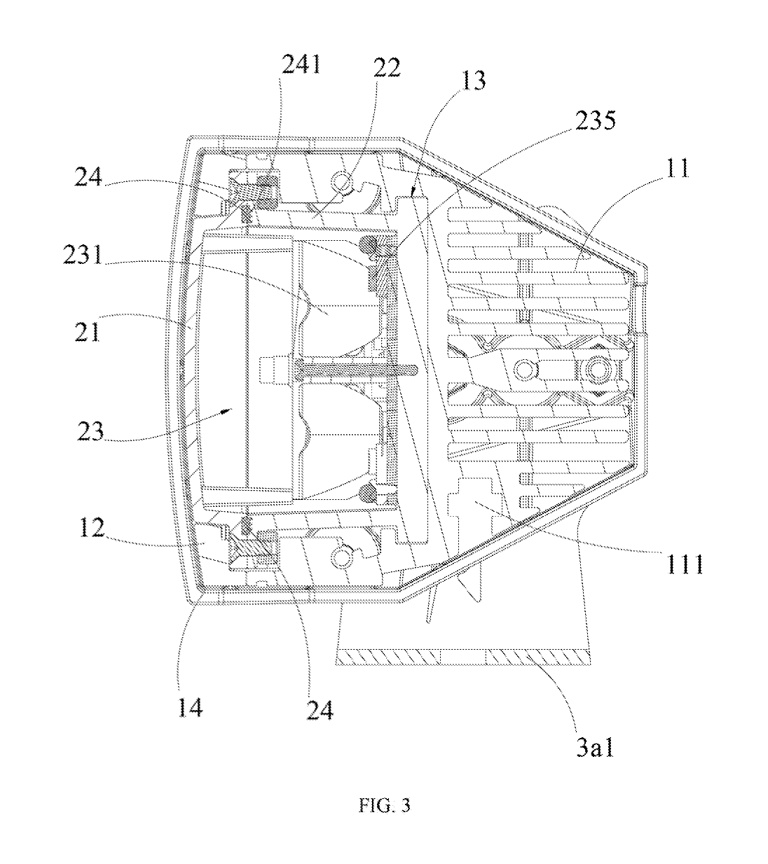

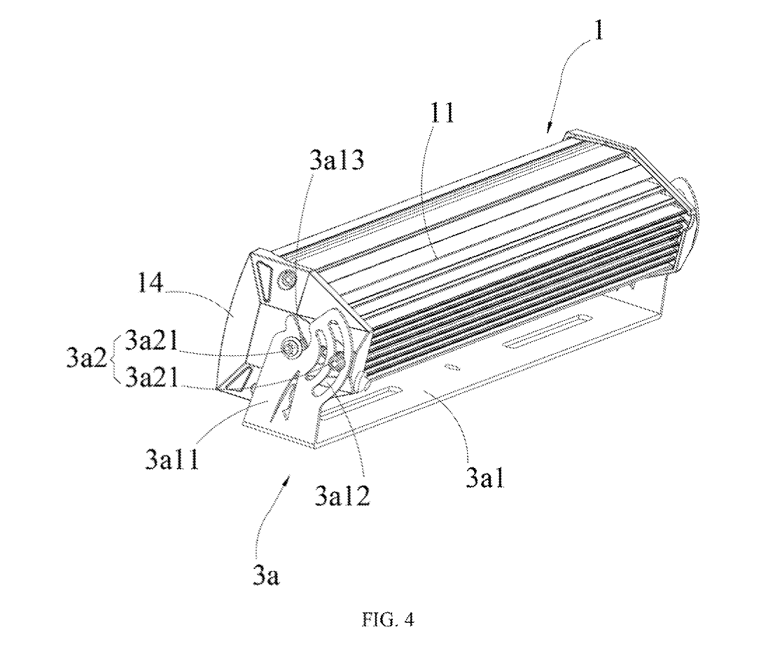

Please refer to FIG. 2 and FIG. 3, furthermore, in each of the LED modules 2, a junction part between a cavity 11 and a transparent inner cover 24 is provided with a waterproof adhesive layer 24, and the waterproof adhesive layer 24 can be certainly treated, such that a plurality of waterproof lines 241 are carved on the waterproof adhesive layer 24, and the plurality of waterproof wires 241 are arranged at intervals and in parallel with each other. Both the cavity 22 and the transparent inner cover 21 are formed integrally, that is, both a surface of the cavity 22 and a surface of the transparent inner cover 21 can prevent water vapor from entering the second sealed cavities 23. In this embodiment, in each of the LED modules 2, the junction part between the cavity 22 and the transparent inner cover 21 is provided with the waterproof adhesive layer 24, which can prevent water vapor from entering the second sealed cavities 23 from the junction part; meanwhile, each waterproof adhesive layer 24 is carved to form the plurality of waterproof lines 241, such that a waterproof system of the waterproof adhesive layer 24 possesses a multi-layer protection, the waterproof performance can be effectively improved, and the permeation of water vapor can be isolated essentially. When the cavity 22 and the transparent inner cover 21 are used to press the waterproof adhesive layer 24, a method of dispersedly pressing can be adopted, such that every part of the adhesive layer 24 can be adhered tightly with both the cavity 22 and the transparent inner cover 21, and thus a sealing performance of the waterproof adhere layer 24 can be effectively ensured.

Please refer to FIG. 2, in order to optimize the aforesaid embodiment, the LED lamp further comprises photosensitive elements 233 and information processing devices (not shown in the figures) arranged in each of the second sealed cavities 23 respectively; each photosensitive element 233 is configured mainly for obtaining light intensity information of incident light that enters one of the second sealed cavities 23 from outside, and can be a photosensitive probe that faces to a corresponding transparent inner cover 21; the photosensitive element 233 is usually arranged at a place that is close to a middle part of a second sealed cavity 23, thereby obtaining more accurate light intensity information of the incident light from outside; as for the information processing devices, each of them is mainly used for controlling a lighting effect of each of the LED light sources 231 according to the light intensity information obtained by the photosensitive elements 233, and each information processing device can be arranged on the PCB 233 and electrically connected with the control circuit. When the aforesaid LED lamp is applied in a road light or a car light, an LED lamp often needs to adjust its own light intensity according to the light intensity of surrounding environments, for example, when the LED lamp is applied in a car light, and when driving at night, if there is an obstacle in the front or a moving vehicle in the corner, light emitted by each of the LED light sources 231 irradiates straightly towards the front and is reflected back into the second sealed cavities 23; each photosensitive element 231 obtains the light intensity information of reflected light, which is approximate to the light intensity information of the light emitted by the LED sources 231; the photosensitive element 231 transmits obtained light intensity information to the information processing device; if the light intensity information exceeds a predetermined value of the information processing device, at this moment, the reflected light of the LED lamp may cause a big stimulation to human eyes, and a safe driving of a driver may be affected; for this reason, the information processing device will adjust the control circuit automatically so as to reduce current or a voltage of each LED light source 231, and thereby reduce the light intensity of each of the LED light sources 231, so that the reflected light of the light emitted by each of the LED light sources 231 does not stimulate eyes of the driver, and thus a driving safety coefficient can be increased; of course, a power-saving effect can also be achieved.

In a further optimization of the aforesaid embodiment: the LED lamp further comprises a mounting support 3, the lamp body 1 is fixed to a mounting member (not shown in the figures) through the mounting support 3. Moreover, the mounting support 3 can also be used to adjust a mounting angle of the lamp body 1, thereby capable of playing a role of adjusting a light-emitting angle of the LED lamp. In an actual application process, according to different requirements, the LED lamp should have different light-emitting angles, thereby achieving an optimal illumination effect. In assembly, the mounting support 3 in this embodiment can make the lamp body 1 be orientated towards a different angle according to a user's requirement, and thus has a higher adaptability. Furthermore, each of the second sealed cavities 23 is provided therein with a laser transmitter 234; by the laser transmitter 234, more intense light beam can be effectively emitted; the laser transmitter 234 faces to a corresponding transparent inner cover 21, and the intense light beam is emitted from the transparent inner cover 21. In order to adjust the light-emitting angle of the LED lamp conveniently, the adjusting time is usually determined as a day; when the mounting support 3 is adopted to adjust the mounting angle of the lamp body 1, the mounting angle of the lamp body 1 should be determined according to the light emitting angle of the LED lamp; however, since it is difficult to see light emitted by each of the LED light sources 231 clearly in the day, the determination of the mounting angle of the lamp body 1 may be affected. For this reason, in this embodiment, each of the second sealed cavities 23 is provided therein with a laser transmitter 234, and the intense light beam emitted by the laser transmitter 234 is substantially a beam spot, which can be clearly seen even in the day, and thus it can be very convenient to adjust the mounting angle of the lamp body 1, and an adjustment of the light-emitting angle of the LED lamp can be further achieved. With respect to the laser transmitter 234 and each of the LED light sources 231, they should be independently controlled; when the mounting angle of the lamp body 1 needs to be adjusted, only the laser transmitter 234 needs to emit light, and the LED light sources 231 should not emit light; when a normal illumination is performed, each of the LED light sources 231 should be controlled to emit light, and the laser transmitter 234 should not emit light, such that human eyes are avoided from being stimulated by an intense light beam.

With respect to the mounting support 3, various structural forms can be adopted.

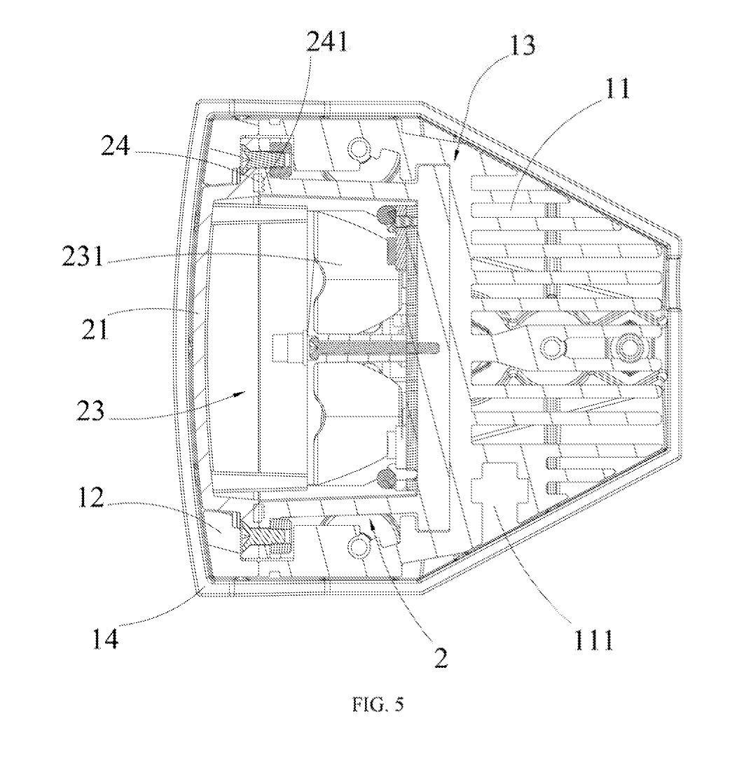

Please refer to FIG. 4, in one structure of the mounting support 3, a mounting support 3a includes a mounting base 3a1 and two connecting components 3a2, the mounting base 3a1 can be fixed to a mounting member, and the two connecting components 3a2 are configured to fix the mounting base 3a1 to the lamp body 1; the mounting base 3a1 can be a U-shaped structure and has two connecting ends 3a11, the two connecting ends 3a11 are arranged oppositely and connected with the two corresponding connecting components 3a2 respectively; each of the two connecting ends 3a11 has arc-shaped sliding grooves and a locating hole 3a13, wherein the locating hole 3a13 should be located at a center of circle of one of the arc-shaped sliding grooves 3a12; of course, the two locating holes 3a13 of the two connecting ends 3a11 should be located collinearly; correspondingly, each of the two connecting components 3a2 comprises two first connecting rods 3a21, by the two first connecting rods 3a21, one of the two connecting ends 3a11 of the mounting base 3a1 can be fixed to the lamp body 1. Specifically, one of the two first connecting rods 3a21 passes through the locating hole 3a13 of one connecting end 3a11 and is in threaded connection with the lamp body 1, at this moment, a portion of the connecting end 3a11 defining the locating hole 3a13 is fixedly connected with the lamp body 1; the other one of the two first connecting rods 3a21 is slidably arranged in one of the arc-shaped sliding slots and is in threaded connection with the lamp body 1. The two first connecting rods 3a21 are all anti-burglary threaded rods which are locked firmly from outside to inside, so that anti-burglary coefficients thereof can be increased, in addition, the situation that an exposed thread is damaged and is hard to be assembled can be avoided; when one of the threaded rods passes through the locating hole 3a13 and is in threaded connection with the lamp body 1, a threaded cap of the threaded rod presses the connecting end 3a11 on the lamp body 1; when another threaded rod is slidably arranged in one arc-shaped sliding groove 3a12 and is in threaded connection with the lamp body 1, a threaded cap of the threaded rod presses two sides of the arc-shaped sliding grove 3a12 on the lamp body 1, thereby enabling the connecting end 3a11 to be fixed to the lamp body 1. When the mounting angle of the lamp body 1 needs to be adjusted, a fixing state between the connecting end 3a11 and the lamp body 1 is relieved firstly, that is, the two first connecting rods 3a21 of each of the connecting components 3a2 are released; of course, the threaded connections between the two first connecting rods 3a21 and the lamp body 1 are still maintained, and only a pressing effect of each of the first connecting components 3a21 acting on a corresponding connecting end 3a11 is relieved; at this moment, the mounting base 3a1 is rotatable relative to the two first connecting rods 3a21, since the mounting base 3a1 is fixed to the mounting member, the lamp body 1 can be rotated around the locating hole 3a13. Since the locating hole 3a13 is positioned at a center of circle of one arc-shaped sliding groove 3a12, one first connecting rod 3a21 of the connecting component 3a2 slides along the arc-shaped sliding groove 3a12, thereby achieving the adjustment of the mounting angle of the lamp body 1; and when the mounting angle of the lamp body 1 has been appropriately adjusted, the first connecting rod 3a21 is rotated again, such that the two connecting ends 3a11 of the mounting base 3a1 are fixed to the lamp body 1, and thus the lamp body 1 is fixed to the mounting member 3a1. In this structure, when the two connecting components 3a2 are fixed to or released from the two connecting ends 3aa11, operations for the two connecting components 3a2 and the two connecting ends 3a11 should be maintain to be synchronous.

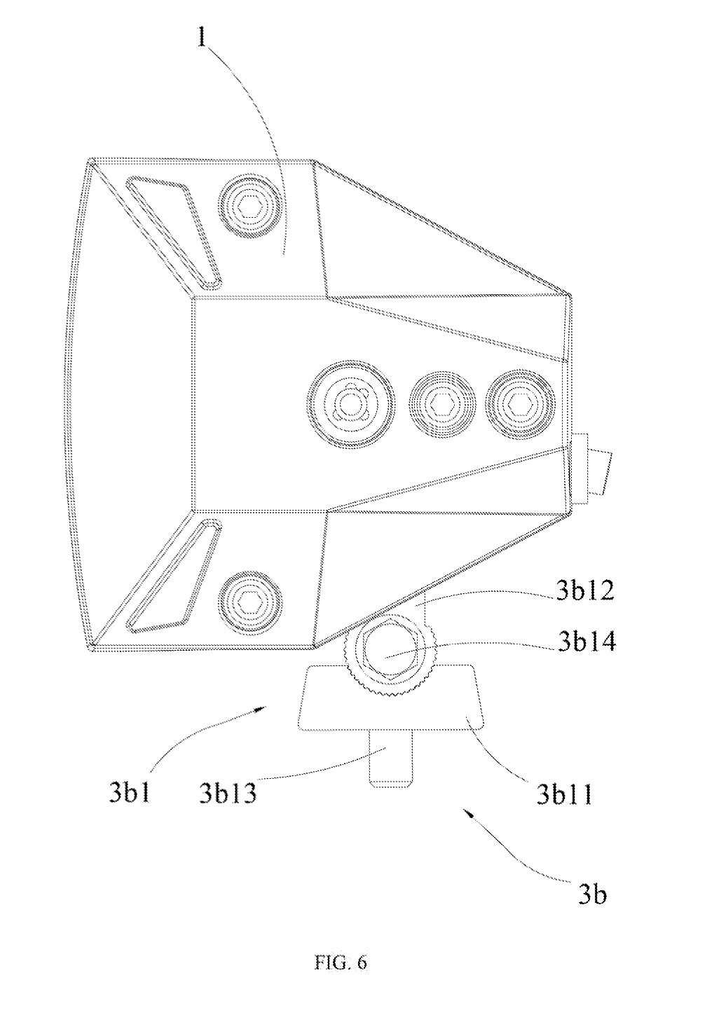

Please refer to FIG. 5 and FIG. 6, in another structure of the mounting support 3, the mounting support 3b comprises a plurality of groups of hook components 3b1, each group of hook components 3b1 comprise a mounting pad 3b11, a connecting base 3b12, and a second connecting rod 3b13, the mounting pad 3b11 is fixed on a mounting member and meshes with the connecting base 3b12, the second connecting rod 3b13 is perpendicular to a meshing plane of the mounting pad 3b11, and the connecting base 3b12 is connected with the lamp body 1; the second connecting rod 3b13 can be a threaded rod which passes through the mounting pad 3b11, and the second connecting rod 3b13 is locked firmly with the mounting pad 3b11 by at least one nut; the connecting base 3b12 is provided with a connecting shaft 3b14, and the second connecting rod 3b13 is provided with a connecting hole (not shown in the figures) configured to be traversed by the connecting shaft 3b14, the connecting shaft 3b14 is perpendicular to a length direction of the second connecting rod 3b13, and an inner diameter of the connecting hole is bigger than a diameter of the connecting shaft 3b14. In this structure, when the lamp body 1 is fixed to the mounting member, each mounting pad 3b11 is fixed to the mounting member, the second connecting rod 3b13 is firmly locked with the mounting pad 3b11, and it is ensured that the mounting pad 3b11 meshes with the connecting base 3b12 stably; moreover, the second connecting rod 3b13 is hung above the connecting shaft 3b1 and then limits a movement of the connecting base 3b12 along the second connecting rod 3b13; furthermore, the mounting pad 3b11 stably meshes with the connecting base 3b12, and the second connecting rod 3b13 is perpendicular to the meshing plane of the mounting pad 3b11, thereby ensuring the stability of the connection between the mounting pad 3b11 and the connecting base 3b12; when the mounting angle of the lamp body 1 needs to be adjusted, a lock state between the second connecting rod 3b13 and the mounting pad 3b11 is relieved firstly; since the inner diameter of the connecting hole is bigger than the diameter of the connecting shaft 3b14, the connection between the connecting hole and the connecting shaft 3b14 can be released; meanwhile, a meshing connection between the mounting pad 3b11 and the connecting base 3b12 is relieved; at this moment, the mounting angle of the lamp body 1 can be adjusted, and the angle of the connecting base 3b12 changes synchronously along with the rotation of the lamp body 1; when the mounting angle is appropriately adjusted, the connecting base 3b12 is meshed with the mounting pad 3b11 again, and a meshing position between the connecting base 3b12 and the mounting pad 3b11 is changed; the second connecting rod 3b13 is locked firmly with the mounting pad 3b11, so that the connecting base 3b12 can mesh with the mounting pad 3b11 stably; meanwhile, the second connecting rod 3b13 is hung above the connecting shaft 3b14 again, and the lamp body 1 is fixed stably to the mounting member.

In order to optimize the structure of the aforesaid mounting support 3b, the dissipation housing 11 is provided with a sliding slot 111, wherein the sliding slot 111 is arranged along a length direction of the dissipation housing 11; the connecting base 3b12 has a connecting part (not shown in the figures), and the connecting part is slidably arranged in the sliding slot 111 and snap-fits with the sliding slot 111. In this structure, a lock state between the second connecting rod 3b13 and the mounting pad 3b11 can be relieved, such that the second connecting rod 3b13 is not hung above the connecting shaft 3b14; at this moment, there is no snap-fitting connection between the connecting part and the sliding slot 111; the connecting part can be slid along the sliding slot 111, such that the second connecting rod 3b13 and the mounting pad 3b11 are locked firmly again, and the connecting part 3b12 is snap-fitted into the sliding slot 111 again; in this way, a supporting position of the mounting support 3b with respect to the lamp body 1 is changed. That is, in this embodiment, according to an actual situation, the connecting base 3b can be slid along the sliding slot 111 so as to change the supporting position of the mounting support 3b with respect to the lamp body 1, and thereby ensure the stability of the assembly of the lamp body 1.

Referring to FIG. 2 again, furthermore, each chamber body 22 is provided with two embedded connection terminals 221, an inner side of each connection terminal 221 is electrically connected with the control circuit of the PCB 232 in a corresponding second sealed cavity 23, and an outer side of each connection terminal 221 is configured to be electrically connected with an external wiring of the chamber body 22; the connection terminal 221 can be formed by casting through a hydraulic cutting presser. In this structure, the two connection terminals 221 are embedded in the chamber body 22 and are configured to electrically connect the control circuit in the second sealed cavity 23 with the external wiring outside of the cavity 22, so as to form an electrical conduction and thereby achieve lighting functions of the LED light sources 231 in the second sealed cavity 23. Moreover, by the two connection terminals 221, electric signals inside and outside the second sealed cavity 23 are electrically conductive; the connecting terminals 221 can be better embedded in the chamber body 22 and form a physical insulation, external water vapor is not prone to permeate into the second sealed cavity 23 along the external wiring, and thus an excellent waterproof effect can be achieved.

When the first sealed cavity 23 is provided therein with a group of LED module 2, the inner sides of both the two connection terminals 221 embedded in the chamber body 22 are electrically connected with the PCB 232, and the outer sides of the two connection terminals 221 are respectively electrically connected with an input wire and an output wire of the lamp body 1, such that the control circuit in the second sealed cavity 23 forms a complete circuit; at this moment, the input wire of the lamp body 1 is regarded as the input wire of the cavity 22, and the output wire of the lamp body 1 is regarded as the output wire of the cavity 22.

When the first sealed cavity 23 is provided therein with a plurality of groups of LED modules 2, the LED modules 2 are arranged linearly and sequentially; one connection terminal 221 of each of the LED modules 2 located in the middle is connected in an insertion manner with one connection terminal 221 of a previous LED module 2, and the other connection terminal 221 of the middle LED module 2 is connected in an insertion manner with one connection terminal 221 of a following LED module 2; at this moment, the input wire of the previous LED module 2 is the output wire of the following LED module 2; one connection terminal 221 of the LED module 2 at one end is connected in an insertion manner with one connection terminal 221 of an adjacent LED module 2, and the other connection terminal 221 of the LED module 2 at one end is electrically connected with the input wire of the lamp body 1; at this moment, the input wire of the chamber body 22 is the input wire of the lamp body 1, and the output wire of the chamber body 22 is the input wire of the adjacent LED module 2; correspondingly, one connection terminal 221 of the LED module at the other end is connected in an insertion manner with one connection terminal 221 of an adjacent LED module 2, and the other connection terminal 221 of the LED module 2 at the other end is electrically connected with the output wire of the lamp body 1; at this moment, the output wire of the cavity 22 is the output wire of the lamp body 1, and the input wire of the chamber body 23 is the output wire of the adjacent LED module 2. In this structure, adjacent ones of the LED modules 2 are detachably assembled together, and an electric connection between every two adjacent LED modules 2 is implemented by an insertion connection between two connection terminals 221. Therefore, when any one of the LED modules 2 is damaged, it is quite convenient to replace the damaged LED module 2.

Referring to FIG. 3 and FIG. 4, furthermore, the lamp body 1 further includes two lateral cover plates 14, the two lateral cover plates 14 are arranged oppositely and disposed on an outer surface of the dissipation housing 11; in a certain extent, the two lateral cover plates 14 can provide a function of reinforcing an inner wall of the first sealed cavity 13 and thereby protecting the dissipation housing 11 effectively; meanwhile, both the input wire and the output wire of the lamp body 1 can extend out from the two lateral cover plates 14. When the structure of the mounting base 3a11 is applied in the mounting support 3, the two connecting ends 3a11 of the mounting base 3a1 can be fixed to the two lateral cover plates 14 respectively through the two connecting components 3a2; when the structure of the hook component 3b1 is applied in the mounting support 3, the two lateral cover plates 14 can provide a function of blocking the sliding slot 111. Of course, the two lateral cover plates 14 are plate-like structures, which can be labeled with a trademark, a logo, or the like. With respect to the second sealed cavities 23, each of the second sealed cavities 23 can be additionally provided therein with an LED backlight 235, the LED backlight 235 can emit color light and can be independently controlled; in this way, when the LED lamp works, according to the user's requirement, a light irradiation and a lighting intensity of the LED backlight 235 can be controlled; further in combination with the light irradiation of each of the LED light sources 231, the LED lamp is enabled to emit light with different colors.

The embodiment of the present application further provides an LED lamp set, which comprises a plurality of the aforesaid LED lamps, the LED lamps are arranged in a straight line, and adjacent ones of the LED lamps are detachably assembled together and electrically conductive. In this embodiment, the plurality of LED lamps are assembled to be a whole, and the LED lamp set has a better whole lighting effect. Meanwhile, since adjacent ones of the LED lamps are detachably assembled together, it is quite convenient to replace any one of the LED lamps in the LED lamp set.

The aforementioned embodiments are only preferred embodiments of the present application, and the structures thereof should not be limited to be the aforesaid shapes listed above. Any modification, equivalent replacement, improvement, and so on, which are made within the spirit and the principle of the present application, should be included in the protection scope of the present application.

1. A waterproof LED lamp comprising a lamp body, wherein the lamp body comprises a dissipation housing having an open slot and a transparent outer cover, the transparent outer cover and the dissipation housing are assembled together to form a first sealed cavity; the first sealed cavity is provided therein with at least one group of LED modules, each of the LED modules comprises a chamber body and a transparent inner cover, the transparent inner cover and the chamber body are assembled together to form a second sealed cavity, and each transparent inner cover faces the transparent outer cover; the second sealed cavity is provided therein with a plurality of LED light sources and a PCB having a control circuit, and each of the LED light sources faces the transparent inner cover.

2. The waterproof LED lamp according to claim 1, wherein the dissipation housing is provided thereon with a plurality of vent holes configured for communicating each of the second sealed cavities with exterior space, and each of the vent holes is provided therein with a waterproof and breathable film configured to prevent external water vapor from entering each of the second sealed cavities.

3. The waterproof lamp according to claim 1, further comprising photosensitive elements which are arranged respectively in each of the second sealed cavities so as to obtain light intensity information of incident light that enters each of the second sealed cavities from the exterior space and directly face the transparent inner covers, and information processing devices configured to process information obtained by the photosensitive elements so as to control each of the LED light sources to emit light.

4. The waterproof LED light according to claim 1, wherein each of the second sealed cavities is provided therein with an LED backlight source configured to emit color light.

5. The waterproof lamp according to claim 1, further comprising a mounting support configured to fix the lamp body to a mounting member and capable of adjusting an mounting angle of the lamp body, the mounting support comprises a mounting base that can be fixed on the mounting member and two connecting components configured to fix the mounting base to the lamp body; the mounting base has two connecting ends arranged oppositely and connected with the two connecting components correspondingly, each of the connecting ends is provided with arc-shaped sliding grooves and a locating hole, the locating hole is located at a center of a circle of one of the arc-shaped sliding grooves; each of the connecting components comprises two first connecting rods configured to fix one of the connecting ends to the lamp body, one of the connecting rods passes through and is fixed in the locating hole and is in threaded connection with the lamp body, the other one of the first connecting rods is slidably arranged in the sliding slots and is in threaded connection with the lamp body.

6. The waterproof LED lamp according to claim 5, wherein each of the chamber bodies is provided therein with a laser transmitter configured to emit an intense light beam.

7. The waterproof LED lamp according to claim 5, wherein: each of the chamber bodies is provided with two embedded connecting terminals, an inner side of each of the connecting terminals is electrically connected with a control circuit of the PCB, and outer sides of the two connecting terminals are respectively electrically connected with an input wire and an output wire of the cavity.

8. The waterproof LED lamp according to claim 7, wherein the first sealed cavity is provided therein with one group of LED module, an inner side of each of the two connection terminals is electrically connected with the PCB, and outer sides of the two connection terminals are respectively electrically connected with an input wire and an output wire of the lamp body.

9. The waterproof LED lamp according to claim 7, wherein the first sealed cavity is provided therein with a plurality of groups of LED modules, the LED modules are arranged linearly and sequentially; one connecting terminal of each of the LED modules located in the middle is connected in an insertion manner with one connecting terminal of a previous LED module, and the other connecting terminal of the LED module is connected in an insertion manner with one connecting terminal of a following LED module; one connecting terminal of an LED module located at one end is connected in an insertion manner with one connecting terminal of an adjacent LED module, and the other connecting terminal of the LED module located at the end is electrically connected with the input wire of the lamp body; one connecting terminal of the LED module located at the other end is connected in an insertion manner with an connecting terminal of an adjacent LED module, and the other connecting terminal of the LED module located at the other end is electrically connected with the output wire of the lamp body.

10. An LED lamp set comprising a plurality of waterproof LED lamps according claim 1, wherein each of the waterproof LED lamps are arranged linearly, and adjacent ones of the waterproof LED lamps are electrically conductive and detachably connected.

11. An LED lamp set comprising a plurality of waterproof LED lamps according to claim 9, wherein each of the waterproof LED lamps are arranged linearly, and adjacent ones of the waterproof LED lamps are electrically conductive and detachably connected.
